(19) United States
(12) Patent Application Publication
(10) Pub. No.: US 2009/0205479 A1
(43) Pub. Date: Aug. 20, 2009

(54) Method and Apparatus for Generating Musical Sounds

(75) Inventor: Shunsuke Nakamura, Kitakyushu-Shi (JP)

Correspondence Address: KRATZ, QUINTOS & HANSON, LLP, 1420 K Street, N.W., Suite 400, WASHINGTON, DC, 20005, US

(73) Assignee: National University Corporation Kyushu Institute Of Technology, Fukuoka (JP)

(21) Appl. No.: 11/884,452

(22) PCT Filed: Jan. 6, 2006
(86) PCT No.: PCT/JP2006/300047

§ 371 Date: Aug. 16, 2007

(30) Foreign Application Priority Data
Feb. 24, 2005 (JP) 2005-049727

(51) Int. Cl. G10H 1/00

(52) U.S. Cl. 84/604

(57) ABSTRACT

The present invention provides to generate musical sound data easily for people to enjoy playing. A musical sound generating apparatus 10 comprises a vibration recognizing means 12, a main control device 14, an acoustic device 16 and a display device 18. The vibration recognizing means 12 is a vibration sensor that generates vibration data by people clapping their hands or tapping on something. The vibration data processing unit 20 analyzes a waveform of the vibration data to extract a waveform component. Based on the waveform component, a musical sound data generating unit 22 generates musical sound data. The acoustic device 16 causes a musical sound according to a musical sound signal.

### TECHNICAL FIELD

The present invention relates to a musical sound generating method and apparatus for generating musical sounds.

### BACKGROUND ART

In recent years, digital multimedia technology is developing and electronic musical instruments are spreading. In such circumstances, it is an important subject how exactly sounds of an acoustic musical instrument are reproduced, while producing expressive musical sounds having a great variety is of great interest.

As an electronic musical instrument that can produce the above expressive musical sounds having a great variety, an electronic percussion instrument that controls a musical sound signal according to a sensing signal detected by a hitting sensor is disclosed, for example (see patent literature 1).

### Patent Literature 1: Japanese Patent Laid-Open No. 2002-221965

However, the above electronic percussion instrument is only an electronized version of a conventional percussion instrument in which tone colors are increased. It is still a kind of a percussion instrument, which requires a special technique or knowledge to perform. Because of this, ordinary people who wish to enjoy music cannot actually use such an electronic percussion instrument easily.

In view of the above problem, it is an object of the present invention to provide a musical sound generating method and apparatus for easily generating musical sound data and which people can enjoy playing with.

### DISCLOSURE OF THE INVENTION

In order to accomplish the above object, a musical sound generating method according to the present invention is characterized by including:

a vibration data obtaining step of obtaining vibration data by a vibration sensor;

a waveform component extracting step of extracting a waveform component from the vibration data; and

a musical sound data generating step of generating musical sound data based on the extracted waveform component.

The musical sound generating method according to the present invention is further characterized in that said musical sound data is established musical score data, and is configured such that a melody of the musical score data varies based on said extracted waveform component.

The musical sound generating method according to the present invention is characterized by further including a musical sound outputting step of controlling a sound source based on the generated musical sound data and outputting musical sounds.

The musical sound generating method according to the present invention is further characterized by using said vibration sensor arranged to be attached/detached on a pre-determined location.

The musical sound generating method according to the present invention is further characterized in that said musical sound data is musical instrument data.

The musical sound generating method according to the present invention is characterized by further including a musical sound data saving step of saving said musical sound data.

The musical sound generating method according to the present invention is characterized by further including an image data generating and image outputting step of generating image data based on said waveform component and outputting an image.

The musical sound generating method according to the present invention is characterized by further including an image data saving step of saving said image data.

Further, a musical sound generating apparatus according to the present invention is characterized by comprising:

vibration recognizing means arranged to be attached/detached on a pre-determined location;

vibration data obtaining means for obtaining vibration data by vibration recognizing means;

waveform component extracting means for extracting a waveform component from the vibration data; and

musical sound data generating means for generating musical sound data based on the extracted waveform component.

The musical sound generating apparatus according to the present invention is further characterized in that said musical sound data is established musical score data, and is configured such that a melody of the musical score data varies based on said extracted waveform component.

The musical sound generating apparatus according to the present invention is characterized by further comprising musical sound outputting means for controlling a sound source based on the generated musical sound data and outputting musical sounds.

The musical sound generating apparatus according to the present invention is further characterized in that said musical sound data is musical instrument data.

The musical sound generating apparatus according to the present invention is characterized by further comprising musical sound data saving means for saving said musical sound data.

The musical sound generating apparatus according to the present invention is characterized by further comprising image data generating and image outputting means for generating image data according to said waveform data and outputting an image.

The musical sound generating apparatus according to the present invention is characterized by further comprising image data saving means for saving said image data.

The method and apparatus for generating musical sounds according to the present invention can generate musical sound data easily only by manipulation to cause appropriate vibration in order to generate the musical sound data based on the vibration data obtained by the vibration sensor.

Further, with the method and apparatus for generating musical sounds according to the present invention, people can enjoy playing through outputting musical sounds based on the generated musical sound data.

### BRIEF DESCRIPTION OF THE DRAWINGS

FIG. 1 is a drawing showing overall configuration of a musical sound generating apparatus according to the present invention.

FIG. 2 is a drawing illustrating a mechanism to decide a musical instrument with reference to a musical instrument database depending on the material of a vibration source.

FIG. 3 is a drawing illustrating a mechanism to decide the velocity of a musical sound depending on the way of applying vibration.

FIG. 4 is a drawing illustrating a mechanism to synchronize generation of sounds and generation of an image.

FIG. 5 is a drawing showing the flow of a processing procedure to generate musical sounds by a musical sound generating apparatus according to the present invention.

### DESCRIPTION OF SYMBOLS

10 musical sound generating apparatus
12 vibration recognizing means
14 main control device
16 acoustic device
18 display device
20 vibration data processing unit
22 musical sound data generating unit
24 image data generating unit
26 MIDI sound source
28 clock
30 vibration data obtaining unit
32 waveform component extracting unit
34 musical sound data deciding unit
36 musical sound database
38 image data deciding unit
40 image database
42 data transferring/saving unit
44 data transferring unit
43 data saving unit

### BEST MODE FOR CARRYING OUT THE INVENTION

The following will describe an embodiment of a method and an apparatus for generating musical sounds according to the present invention.

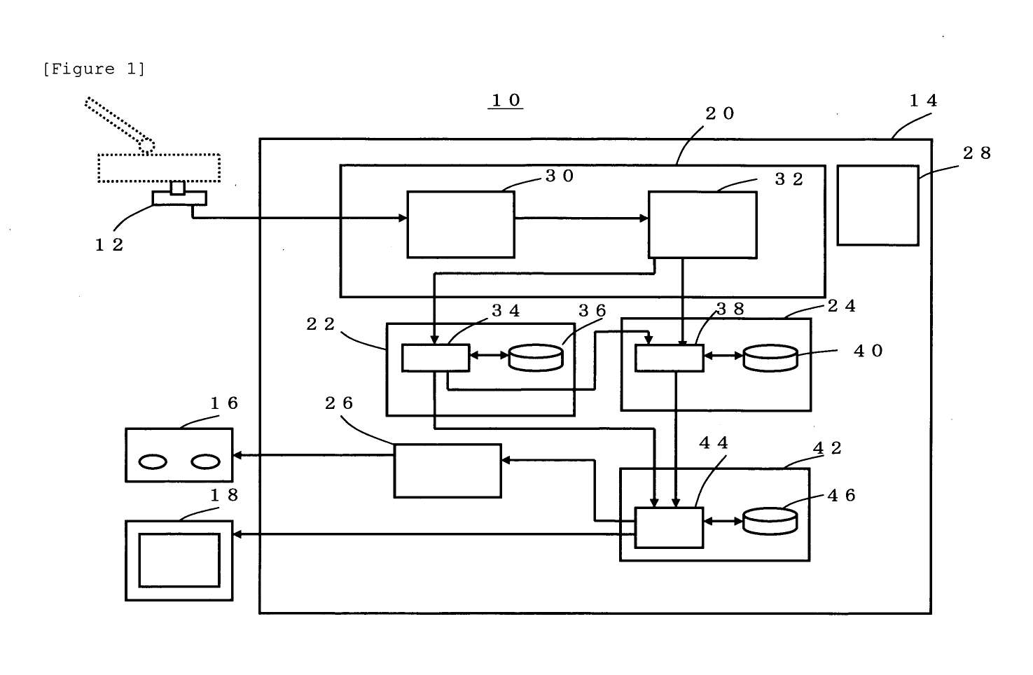

First, overall configuration of the musical sound generating apparatus according to the present invention will be described with reference to FIG. 1.

A musical sound generating apparatus 10 according to the present invention comprises vibration recognizing means 12, a main control device 14, an acoustic device (musical sound outputting means) 16 and a display device (image outputting means) 18.

The vibration recognizing means 12 is a vibration sensor that transforms impact or vibration it accepted (sensed) into a waveform. The vibration recognizing means 12 includes an acoustic sensor.

The vibration sensor can be a contact or noncontact type. The vibration recognizing means 12 is a suction cup, a clip or a needle, for example, which is provided to be installed on any location. The means 12 accepts, for example, vibration generated on a hitting board by hitting the hitting board as a vibration originating source with the installed vibration recognizing means 12 with a stick, as shown in FIG. 1. The vibration recognizing means 12 can recognize (accept) not only a sound (vibration) generated by people clapping their hands or tapping on something, but also vibration from various kinds of vibration sources. The vibration recognizing means 12 can also be a Doppler sensor for recognizing the air current or a pressure sensor for recognizing the severity of force being applied.

The main control device 14 is a PC, for example, that processes a vibration data signal from the vibration recognizing means 12, sends a musical sound signal to the acoustic device 16, and sends an image signal to the display device 18. Detailed configuration of the main control device 14 will be described later.

The acoustic device 16 is a speaker system, for example, that causes musical sounds from a musical sound signal.

The display device 18 is an LCD display, for example, that displays an image according to an image signal.

In the above configuration, the acoustic device 16 and the display device 18 can be integrated into the main control device 14. Or, the display device 18 can be omitted as necessary.

The main control device 14 will be further described.

The main control device 14 comprises a vibration data processing unit 20, a musical sound data generating unit (musical sound data generating means) 22, an image data generating unit (image data generating means) 24, a data transferring/saving unit 42, a MIDI sound source 26, for example, as a sound source, and a clock 28.

The vibration data processing unit 20 comprises a vibration data obtaining unit (vibration data obtaining means) 30 for obtaining vibration data from the vibration recognizing means 12, and a waveform component extracting unit (waveform component extracting means) 32 for analyzing a waveform of the obtained vibration data and extracting a characteristic waveform component (waveform data) that triggers musical sound generation.

The vibration accepted by the vibration recognizing means 12 is captured as vibration data (waveform data) by the vibration data processing unit 20 at pre-determined time. From the vibration data, waveform data per each unit of time is obtained.

From the waveform data, the waveform component extracting unit 32 extracts a waveform component using FFT (Fast Fourier transform), for example. The extracted waveform component is, for example, the energy amount of the waveform or a frequency distribution profile pattern of the waveform.

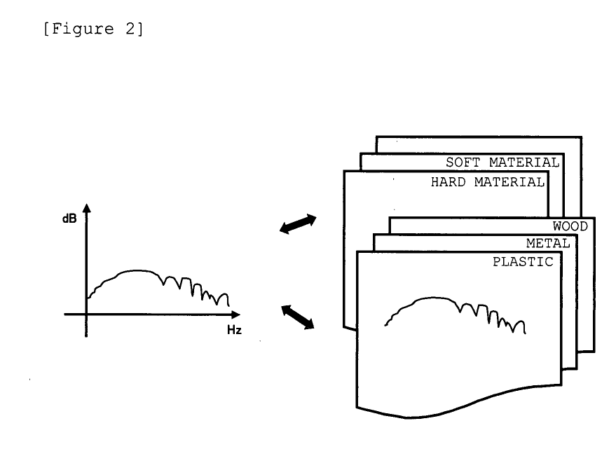

This data processing serves to distinguish a fund of information including the kind of energy applied to the vibration source such as the volume of the given vibration, the strength of force, the force of air and the like, or whether the vibration was caused by hitting, touching, rubbing or the like, or the material of the vibration source such as something hard, something soft, wood, metal, plastic or the like (see FIG. 2).

The musical sound data generating unit 22 generates musical sound data based on the waveform component extracted by the vibration data processing unit 20.

The musical sound data generating unit 22 comprises musical sound data deciding unit 34 for generating MIDI data and a musical sound database 36.

The musical sound database 36 includes a MIDI database, a music theory database and a musical instrument database.

In the MIDI database, for example, note numbers (hereinafter referred to as notes) of MIDI data are assigned to positions (numerical values) to divide a range from the maximum value to the minimum value of the energy amount of a waveform into twelve parts, as shown in table 1. The musical sound data deciding unit 34 decides a note, i.e. a musical scale corresponding to the energy amount of a waveform got by the waveform component extracting unit 32 as musical sound data. In the above, real-time processing is possible to generate the MIDI data.

Also in the above, a sampler can be used as a MIDI sound source to make various sounds other than those of musical instruments. For example, if an instruction (a musical score) to make cats' meows is embedded in a musical score file (MIDI file), then the meows can be sounded during a phrase of a melody while a child performs “Inu no Omawari-san (Mr. Dog Policeman)”.

TABLE 1

| position | 0 | 1 | 2 | 3 | 4 | 5 | 6 | 7 | 8 | 9 | 10 | 11 |
|---|---|---|---|---|---|---|---|---|---|---|---|---|
| note | 60 | 61 | 62 | 63 | 64 | 65 | 66 | 67 | 68 | 69 | 70 | 71 |

The music theory database includes, for example, data of a musical scale on a code (a C code herein) or an ethnic musical scale (an Okinawan musical scale herein) as shown in table 3 depending on positions (numerical values) to divide a range from the maximum value to the minimum value of the energy amount of a waveform into twelve parts as shown in table 2. In the musical sound data deciding unit 34, a musical scale is generated to which is applied a music theory corresponding to the energy amount of a waveform got by the waveform component extracting unit 32. This allows for preventing a noisy sound and moreover getting preferred strains of music, for example.

TABLE 2

| position | 0 | 1 | 2 | 3 | 4 | 5 | 6 | 7 | 8 | 9 | 10 | 11 |
|---|---|---|---|---|---|---|---|---|---|---|---|---|
| note | 43 | 48 | 52 | 55 | 60 | 64 | 67 | 72 | 76 | 79 | 84 | 88 |

TABLE 3

| position | 0 | 1 | 2 | 3 | 4 | 5 | 6 | 7 | 8 | 9 | 10 | 11 |
|---|---|---|---|---|---|---|---|---|---|---|---|---|
| note | 42 | 43 | 55 | 59 | 60 | 64 | 65 | 67 | 71 | 72 | 76 | 77 |

The musical sound database 36 can further include a musical score database.

The musical score database includes, for example, existing musical score data (data of the musical scale order: note) “Choucho (Butterfly)”, as shown in table 4. The musical sound data deciding unit 34 decides the following musical scales in an inputted waveform data order. In this processing, instead of dividing the range depending on whether the energy amount is small or large as above, but the following musical scales can be decided successively irrespective of the fluctuation of a waveform energy before and after being inputted when the energy amount of a waveform is not less than a threshold. However, if the following musical scales should be decided when the increase and decrease of a note matches the fluctuation of the waveform energy before and after being inputted, people can feel as if they are performing music of a musical score by an operation to generate different vibrations successively as they intend. If the energy amount of a waveform is not exceeds the threshold, time to capture vibration data is controlled, and the next musical scale is decided depending on the energy amount of a waveform based on the next vibration data.

In the above, people can feel as if they are performing in their own style by varying a melody through configuration to vary the loudness or velocity of a sound based on an extracted waveform component, to add effects, to add grace notes automatically, or to transform the musical atmosphere into Okinawan music or jazz like one.

TABLE 4

| order | 1 | 2 | 3 | 4 | 5 | 6 | 7 | 8 | 9 | 10 | 11 | . . . |
|---|---|---|---|---|---|---|---|---|---|---|---|---|
| note | 67 | 64 | 64 | 65 | 62 | 62 | 60 | 62 | 64 | 65 | 67 | . . . |
| increase/ | — | ↓ | → | ↑ | ↓ | → | ↓ | ↑ | ↑ | ↑ | ↑ | . . . |
| decrease | | | | | | | | | | | | |
| of note | | | | | | | | | | | | |

The musical instrument database includes, for example, a frequency distribution profile pattern of a waveform for the material of ingredient such as plastic, metal or wood to which vibration is applied, as shown in FIG. 2. In the database, for example, MIDI Program Numbers are also assigned to the material, as shown in table 5. The musical sound data deciding unit 34 performs pattern matching of an inputted waveform component (a frequency distribution profile pattern of the waveform) and a frequency distribution profile pattern of a waveform in the musical instrument database. The unit 34 identifies (recognizes) the material of a vibration source to generate the inputted waveform component as plastic, for example, and decides a musical instrument of Program Number 1 (piano) corresponding to plastic. This allows for selection of a desired musical instrument by selecting ingredient to cause the vibration. In the above, instead of the material of the vibration source, means (a tool) for the vibration source to cause vibration can be associated with a musical instrument, for example, vibration by something hard such as a nail can be associated with a sound of a piano, or vibration generated by something soft such as a palm can be associated with a sound of a flute or the like.

TABLE 5

| material | plastic | metal | wood | . . . |
|---|---|---|---|---|
| MIDI | 1 | 2 | 3 | . . . |
| Program No. | | | | |

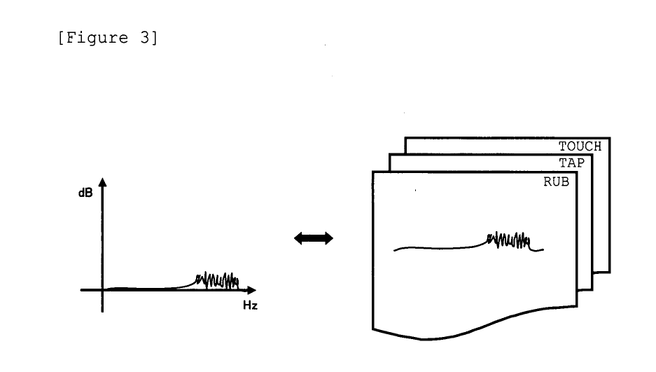

The musical sound database 36 also includes, in relation to the method of deciding a musical instrument by identifying the material of ingredient as above, for example, a frequency distribution profile pattern of a waveform by the way of application (type) of vibration such as by rubbing, tapping or touching, as shown in FIG. 3. The musical sound data deciding unit 34 performs pattern matching of an inputted waveform component (a frequency distribution profile pattern of the waveform) and a frequency distribution profile pattern of a waveform by the way of application (type) of the vibration. If the unit 34 identifies (recognizes), for example, the way of applying vibration by a vibration source to generate the inputted waveform component as by rubbing, the velocity of MIDI is decreased. If the unit 34 identifies (recognizes) the way of applying vibration by the vibration source to generate the inputted waveform component as by tapping, the velocity of MIDI is increased. This allows for changing the volume of a musical sound by changing the way of applying vibration, and hence improving the flexibility of performance.

If, for example, the amount of change of a waveform component got during a pre-determined time interval is not more than a threshold in the musical sound data deciding unit 34, the sound length (tempo) of a musical sound is got through configuration such that musical sound data at the previous time is again generated.

A sound can be deepened through configuration to swiftly generate continuous varying sounds such as 76-79-72-76 as a set of sounds with the note 76 at the core in the musical sound data deciding unit 34 if the material of a vibration source, the way of applying the vibration or the like matches a particular condition, instead of to generate, for example, the note 76 of a music theory (C code) as a single sound, for example, normally depending on a waveform component.

The image data generating unit 24 has, for example, a function to generate image data based on a waveform component extracted by the vibration data processing unit 20. The unit 24 comprises an image data deciding unit 38 and an image database 40.

In the image database 40, image data is assigned to waveform components and saved. The image data can be assigned in a form directly corresponding to a waveform component extracted by the vibration data processing unit 20. However, for example, such configuration is more preferable that generation of a sound and generation (change) of an image are synchronized with each other.

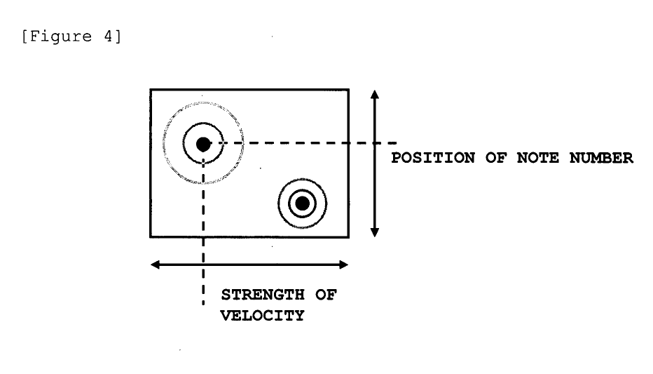

That is, for example, the image database 40 associates the pitch of a musical scale, i.e. the note number, with the top and bottom positions on a screen, and the degree of velocity with the right and left positions, as shown in FIG. 4. Meanwhile, the image data deciding unit 38 generates effect at points on an image defined according to a waveform component where dots scatter (waves ripple out or firework explodes). In this effect, the color of a scattering dot corresponds to the kind of a musical instrument, for example, a shamisen (Japanese three-stringed musical instrument) is red and a flute is blue.

This allows people to strongly feel as if they are performing.

The data transferring/saving unit 42 includes a data transferring unit 44 for temporarily storing respective data sent from the musical sound data generating unit 22 and the image data generating unit 24, and a data saving unit (musical sound data saving means and image data saving means) 46 for saving the data as necessary.

A MIDI sound source 28 contains musical sounds of multiple kinds of musical instruments. The sound source 28 is controlled by a musical sound data signal from the data transferring unit 44, and generates a musical sound signal of a selected musical instrument. According to the musical sound signal, the acoustic device 16 causes musical sounds.

On the other hand, image data generated by an image data generating unit is displayed on the display device 18 according to an image data signal from the data transferring unit 44.

The acoustic device 16 and the display device 18 can be operated simultaneously, or either one of them can be operated at a time.

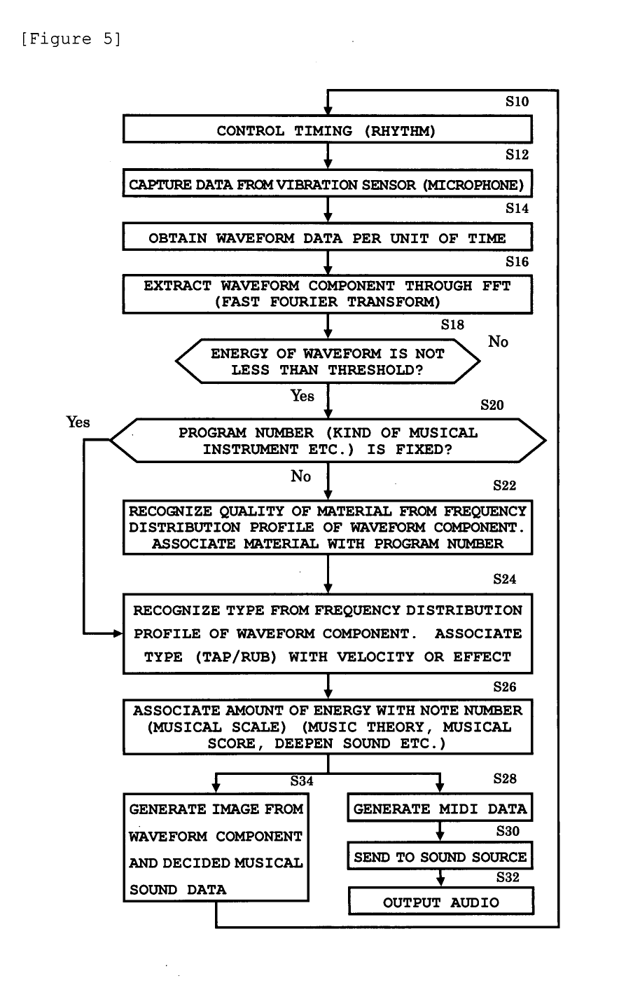

Next, causing of musical sounds by the musical sound generating apparatus 10 according to the present invention and processing of displaying an image will be described with reference to a flowchart in FIG. 5.

At a vibration data obtaining step, while timing (rhythm) is controlled (S10 in FIG. 5), vibration data is obtained by a vibration sensor arranged on a pre-determined location to be attached/detached for use (S12 in FIG. 5).

Then, at a waveform component extracting step, waveform data (a waveform component) per a unit of time is obtained (S14 in FIG. 5). Further, the waveform component is extracted through FFT (Fast Fourier transform), i.e., the waveform component is extracted from the vibration data (S16 in FIG. 5).

Then, at a musical sound data generating step, it is determined whether the energy of a waveform is not less than a threshold (S18 in FIG. 5). If the energy is less than the threshold, timing is again controlled (S10 in FIG. 5). Otherwise, if the energy of the waveform is not less than the threshold, it is determined whether or not the program number (for example, the kind of a musical instrument) is fixed (S20 in FIG. 5).

If the program number is fixed, then the way of applying vibration is recognized such as tapping or rubbing from a frequency distribution profile of the waveform component, and the way is associated with the velocity or effect of MIDI (S24 in FIG. 5). Otherwise, if the program number is not fixed, the material is recognized from the frequency distribution profile of the waveform component, and the material is associated with the program number (S22 in FIG. 5). After that, the way of applying vibration is recognized such as tapping or rubbing from the frequency distribution profile of the waveform component, and the way is associated with the velocity or effect (S24 in FIG. 5).

Then, the energy amount is associated with a note number (musical scale) (S26 in FIG. 5).

The musical sound data is saved as necessary (a musical sound data saving step).

Then, MIDI data is generated (S28 in FIG. 5), sent to the sound source at a musical sound outputting step (S30 in FIG. 5), and audio (musical sounds) is outputted (S32 in FIG. 5).

Meanwhile, at an image generating/outputting step, image data is generated from the musical sound data decided to be a waveform component. The image data is saved as necessary (image data saving step), and outputted as an image (S34 in FIG. 5).

Many people wish they could play musical instruments. Existing musical instruments are for people to be able to represent musical sounds as they wish only after practices. However, those instruments are difficult for people to play as they wish since considerable practices are required to master the instruments. According to the present invention, anyone can easily perform instruments, and a desk or a floor can be readily used as a musical instrument.

Further, according to the present invention, people with different mastery of musical instruments can perform together. For example, children who are regularly practicing play a real guitar or piano, while their father who has not performed any musical instrument takes part in the performance by using the system according to the present invention to tap on a desk. A sequence of musical scales such as by a musical score can be previously set, thereby the father can hold a session with his children only by tapping on a desk.

Furthermore, if people who have an extreme sense for music but does not know a method of displaying the sense or have difficulties in displaying the sense practice a normal musical instrument, they tend to fit a pattern so that they cannot improve their own sense. However, according to the present invention, such people can display the sense irrespective of their techniques.

Still further, although a sound (vibration) of such as a tap dance or a Japanese drum has been normally expressed by beating, the system according to the present invention enables to produce a musical scale simultaneously, thereby expanding possibilities of the performance.

The present invention is not limited to the embodiment described in the above, but sounds can be added by vibration while music as a base is being played, for example, piano sounds are generated at preferred times while only drum sounds is being reproduced.

Further, the strength of vibration is divided into three units, for example, and a sound is generated when an appropriate musical scale is within the range of each unit, such that performance flexibility (a game element) can be added.

1: A musical sound generating method characterized by including:
a vibration data obtaining step of obtaining vibration data by a vibration sensor;
a waveform component extracting step of extracting a waveform component from the vibration data; and
a musical sound data generating step of deciding the next musical scale and generating the scale as musical sound data if a change in the fluctuation of the waveform energy before and after an extracted waveform component being inputted matches a change in pitch of the previous and next musical scales in a database of musical scales in a determined order of performance.

2: The musical sound generating method according to claim 1 characterized in that said musical sound data is musical score data consisting of pre-determined musical scales and is configured such that a melody of the musical score data varies based on said extracted waveform component.

3. (canceled)

4. (canceled)

5: The musical sound generating method according to claim 1 characterized previously generating musical instrument data based on the extracted waveform component.

6. (canceled)

7: The musical sound generating method according to claim 1 or 5 characterized by further including an image data generating and image outputting step of generating image data with image effect based on said waveform data and outputting an image.

8. (canceled)

9: A musical sound generating apparatus characterized by comprising:
vibration recognizing means arranged to be attached/detached on a pre-determined location;
vibration data obtaining means for obtaining vibration data by vibration recognizing means;
waveform component extracting means for extracting a waveform component from the vibration data; and
musical sound data generating means for deciding the next musical scale and generating the scale as musical sound data if a change in the fluctuation of the waveform energy before and after an extracted waveform component being inputted matches a change in pitch of the previous and next musical scales in a database of musical scales in a determined order of performance.

10: The musical sound generating apparatus according to claim 9 characterized in that said musical sound data is musical score data including pre-determined musical scales, and is configured such that a melody of the musical score data varies based on said extracted waveform component.

11. (canceled)

12: The musical sound generating apparatus according to claim 9 characterized data by previously generating musical instrument data based on the waveform component extracted by said musical sound data generating means.

13. (canceled)

14: The musical sound generating apparatus according to claim 9 or 12 characterized by further comprising image data generating and image outputting means for generating image data with image effect based on said waveform data and outputting an image.

15. (canceled)
